(19) United States
(12) Patent Application Publication
(10) Pub. No.: US 2011/0041955 A1
(43) Pub. Date: Feb. 24, 2011

(54) LOG SPLITTING APPARATUS

(76) Inventor: Ambrose Bedel, Greensburg, IN (US)

Correspondence Address: ITALIA IP, 3500 WEST OLIVE AVE., SUITE 300, BURBANK, CA, 91505, US

(21) Appl. No.: 12/545,480

(22) Filed: Aug. 21, 2009

(51) Int. Cl. B27L 7/06

(52) U.S. Cl. 144/195.1; 144/195.8

(57) ABSTRACT

A log-splitting apparatus includes a beam, a backstop coupled to the beam, and a wedge assembly for splitting logs. The wedge assembly is coupled to the beam. An actuating mechanism is provided and is capable of being operated in a first mode, wherein the actuating mechanism is operable to move the beam between a first position and a second position. The actuating mechanism is also capable of being operated in a second mode, wherein the actuating mechanism is operable to move at least one of the wedge assembly and backstop from a log-receiving position to a log-splitting position. The apparatus may include a mode selecting switch for selectively switching the actuating mechanism between the first mode and second mode.

### BACKGROUND OF INVENTION

This application relates to log splitters and more particularly to semi-automated log splitting apparatuses.

### SUMMARY

Splitting logs can be a tedious, time-consuming and dangerous endeavor. In order automate at least a portion of log splitting operations, transportable log-splitting devices have been developed. These devices are typically hydraulically powered and include a moveable backstop which urges a log towards a log-splitting wedge. The wedges of these devices typically wear down over time. Additionally, the wedges and/or backstop typically become loose over time. Moreover, these devices can be difficult to load as a user typically has to lift a log onto the device and situate the log between the wedge and backstop. Therefore, there exists a need for a durable log splitting device that may, in some instances, be easily loaded.

This application discloses a log-splitting apparatus comprising: a beam; a mounting plate assembly coupled to the beam; a wedge assembly for splitting logs, the wedge assembly coupled to the mounting plate assembly and comprising: a rear wall; a first sidewall having a first end and a second end, wherein the first end is coupled to the rear wall; a second sidewall having a first end and a second end, wherein the first end is coupled to the rear wall in spaced relationship relative to the first sidewall first end, and wherein the first side wall and second sidewall are arranged at an acute angle relative to one another such that the first sidewall second end and second sidewall second end are adjacent to one another and such that the rear wall, first sidewall and second sidewall define an interior cavity; one or more inserts disposed within the interior cavity, wherein each of the inserts is coupled to at least one of the rear wall, first wall and second wall; and a wedge tip operable to penetrate a log, the wedge tip coupled to the first sidewall second end and the second sidewall second end; a backstop coupled to the beam; and an actuating mechanism coupled to at least one of the wedge assembly and backstop, the actuating mechanism operable to move at least one of the wedge assembly and backstop from a log-receiving position to a log-splitting position.

This application also discloses a log-splitting apparatus comprising: a beam having a cross-section; a backstop having an aperture for receiving the beam therein, wherein the aperture has a cross-section, and wherein the aperture cross-section and beam cross-section are substantially similar in shape, and wherein the backstop is ridgedly coupled to the beam; a wedge assembly for splitting logs, the wedge assembly coupled to the beam; and an actuating mechanism coupled to the wedge assembly, the actuating mechanism operable to move the wedge assembly from a log-receiving position to a log-splitting position.

This application further discloses a log-splitting apparatus comprising: a beam; a backstop coupled to the beam; a wedge assembly for splitting logs, the wedge assembly coupled to the beam; and an actuating mechanism coupled to the beam and at least one of the wedge assembly and backstop, wherein the actuating mechanism is capable of being operated in a first mode, wherein the actuating mechanism is operable to move the beam between a first position and a second position, and wherein the actuating mechanism is capable of being operated in a second mode, wherein the actuating mechanism is operable to move at least one of the wedge assembly and backstop from a log-receiving position to a log-splitting position.

### BRIEF DESCRIPTION OF THE DRAWINGS

The drawings, when considered in connection with the following description, are presented for the purpose of facilitating an understanding of the subject matter sought to be protected.

FIG. 1 is a top view of an illustrative log-splitting apparatus;

FIG. 2 is a cross-sectional view of the illustrative log-splitting apparatus of FIG. 1 taken along line 2-2;

FIG. 3 is an exploded view of an illustrative wedge assembly;

FIG. 4A is a perspective view of an illustrative mounting plate assembly;

FIG. 4B is a side view of the illustrative mounting plate assembly of FIG. 4A;

FIG. 5 is a perspective view of an illustrative backstop and a portion of an illustrative beam; and

FIG. 6 is a schematic view of an actuating mechanism.

### DETAILED DESCRIPTION

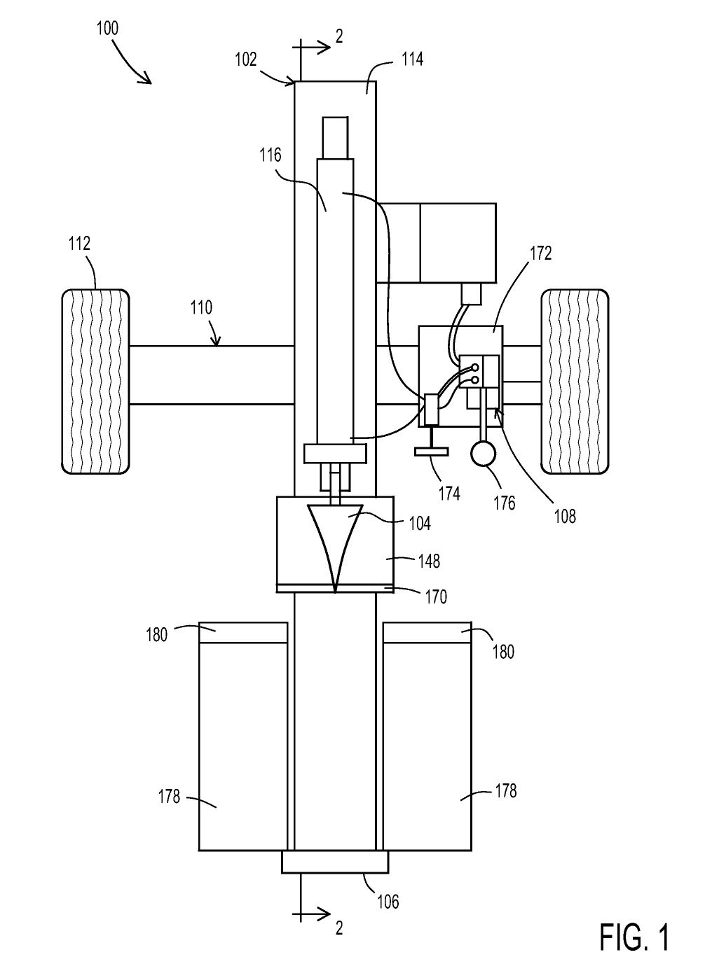

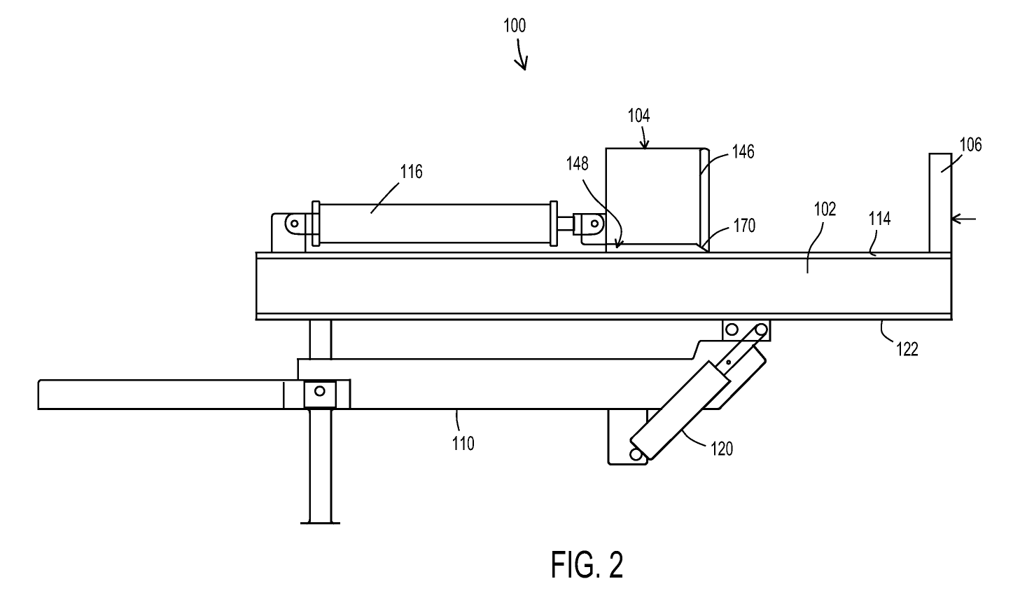

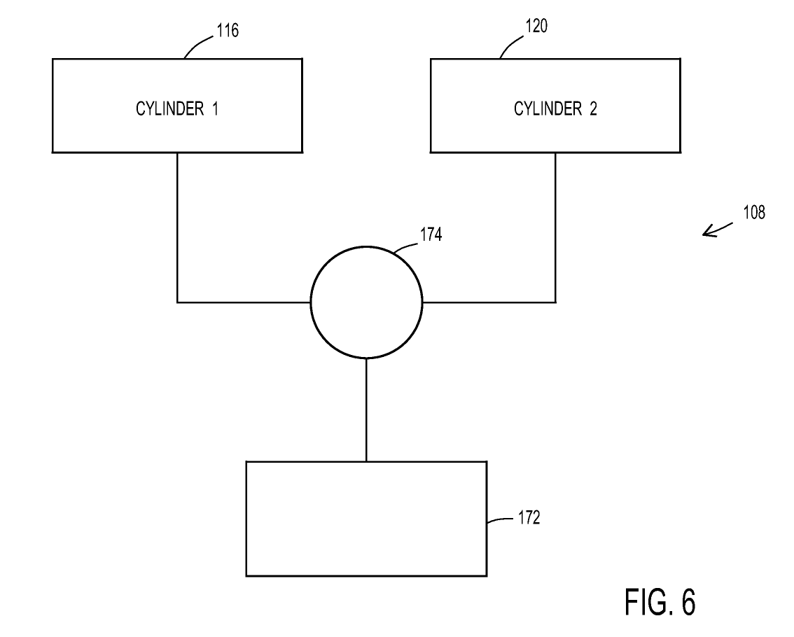

Referring now to FIGS. 1-6, wherein like numerals indicate like elements throughout, a log-splitting apparatus 100 is shown. The log-splitting apparatus 100 generally includes a beam 102, a wedge assembly 104, a backstop 106, and an actuating mechanism 108. The wedge assembly 104 and backstop 106 may coupled to the upper portion 114 of the beam 102. Further, at least some of the components of the actuating mechanism 108 may be coupled to the frame 110 and/or beam 102. In addition, a frame 110 may be coupled to the beam 102, wherein an axle with wheels 112 or the like may be mounted. It will, however, be appreciated that any suitable structure or device for transporting and/or supporting the beam 102 may be coupled to the beam 102. In the illustrative embodiment, the beam 102 is an I-beam; however, any suitably shaped beam may be employed and remain within the scope of the present disclosure.

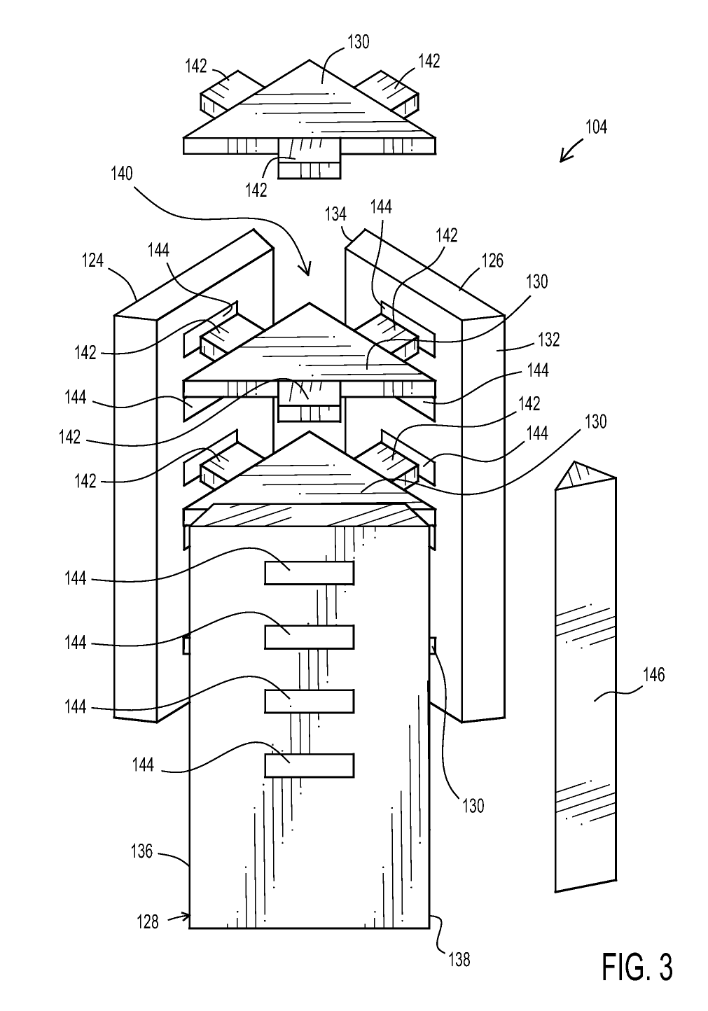

With particular reference to FIG. 3, the wedge assembly 104 is configured to split logs situated between the wedge assembly 104 and the backstop 106. In one embodiment, the wedge assembly 104 includes a rear wall 124, a first sidewall 126, a second sidewall 128, and one or more inserts 130. The first sidewall 126 includes a first end 132 and a second end 134. The first sidewall first end 132 is coupled to the rear wall 124 via any suitable means, including, but not limited to, welding, bonding, adhesive, mechanical fasteners, etc. The second sidewall 128 includes a first end 136 and a second end 138. The second sidewall first end 136 is coupled to the rear wall 124 via any suitable means, including, but not limited to, welding, bonding, adhesive, mechanical fasteners, etc. The first sidewall 126 and second sidewall 128 are arranged at an acute angle relative to one another such that the respective second ends 132, 138 are adjacent to one another. The first sidewall second end 132 and second sidewall second end 138 may be coupled together. The rear wall 124, first sidewall 126 and second sidewall 128 define an interior cavity 140 of the wedge assembly 104. One or more inserts 130 may be disposed within the cavity 140. Each of the inserts 130 may be coupled to at least one of the walls 124, 126, 128. In the illustrative embodiment, each insert 130 includes a plurality of tabs 142 wherein each tab 142 is configured to be received by a corresponding aperture 144 of at least one of the rear wall 124, first sidewall 126, or second sidewall 128 whereby each insert 130 is coupled to at least one wall 124, 126, 128 via insertion of the each tab 142 into a corresponding aperture 144. In the illustrative embodiment, the inserts 130 may have generally triangular cross-sections such that each insert 130 substantially spans the triangularly shaped cross-section of the wedge cavity 140 once the tab(s) 142 are disposed in corresponding aperture(s) 144. However, it will be appreciated that the inserts 130 may have any suitable cross-sectional shape and remain within the scope of the present disclosure. In one embodiment, a wedge tip 146, operable to penetrate logs, may be coupled at the juncture of the first sidewall second end 132 and second sidewall second end 138.

The wedge assembly 104 may be coupled to the beam 102 via any suitable means. As will be discussed further below, in the illustrative embodiment, the wedge assembly 104 may be slidingly coupled to the beam 102 and movable, via the actuating mechanism 108, between a log-receiving position, whereby a log may be loaded into the apparatus 100, and a log-splitting position, whereby a log may be split by the wedge assembly 104. In the illustrative embodiment, the wedge assembly 104 is slidingly coupled to the beam 102 with a mounting plate assembly 148. The wedge assembly 104 may be coupled to the mounting plate assembly 148 via any suitable means, including, but not limited to, welding bonding, adhesive, mechanical fastener(s), etc. In an alternative embodiment, the wedge assembly 104 may be ridgedly coupled to the beam 102 and the backstop 106 moved between a log-receiving position and a log-splitting position via the actuating mechanism 108.

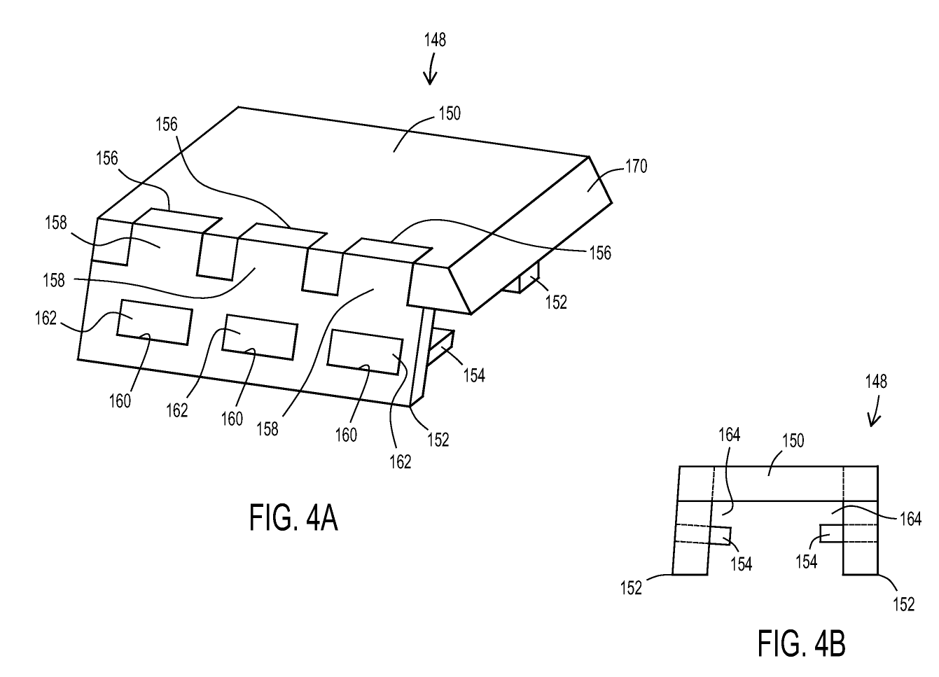

With particular reference to FIGS. 4A-4B, the illustrative mounting plate assembly 148 includes an upper plate 150, one or more side plates 152, and one or more lower plates 154. The upper plate 150 may include an inclined face 170 for lifting a log towards the wedge assembly 104 as the actuating mechanism 108 moves the wedge assembly 104 (and mounting plate assembly 148) to a log-splitting position. In the illustrative embodiment, each side plate 152 is substantially perpendicular to the upper plate 150; however, it will be appreciated that each side plate 152 may be at any suitable angle relative to the upper plate 150. The side plate 152 and upper plate 150 may be coupled by any suitable means, including, but not limited to, welding, bonding, adhesive, mechanical fastener(s), etc. In the illustrative embodiment, the upper plate 150 includes one or more slots 156 whereby each slot 156 is adapted to receive a corresponding projection 158 from a side plate 152. The interface of each slot 156 and each projection 158 may be welded to couple the upper plate 150 to each side plate 152.

In the illustrative embodiment, each lower plate 154 is substantially perpendicular to a corresponding side plate 152 and offset and substantially parallel with the upper plate 150. While each lower plate 154 is shown as substantially perpendicular to a corresponding side plate 152, it will be appreciated that each lower plate 154 may be at any suitable angle relative to a corresponding side plate 152. Moreover, while each lower plate 154 is shown as substantially parallel to the upper plate 150, it will be appreciated that each lower plate 154 may be at any suitable angle relative to the upper plate 150. Each lower plate 154 may be coupled to a corresponding side plate 154 via any suitable means, including, but not limited to, welding, bonding, adhesive, mechanical fastener(s), etc. In the illustrative embodiment, each side plate 152 includes one or more apertures 160, whereby each aperture 160 is adapted to receive a corresponding projection 162 from a lower plate 154. The interface of each aperture 160 and projection 162 may be welded to couple each lower plate 154 to each side plate 152.

A side plate 152, a lower plate 154 and upper plate 150 collectively define a channel 164 operable to slidingly receive the upper portion 114 of the beam 102 such that the mounting plate assembly 148 may be slidingly coupled to the beam 102, whereby the wedge assembly 104, when coupled to the mounting plate assembly 148, may be slidingly coupled to the beam 102. It will be appreciated that the wedge assembly 104 may be slidingly coupled to the beam 102 with any suitable device or means and the present disclosure is not limited solely to the illustrative mounting plate assembly 148.

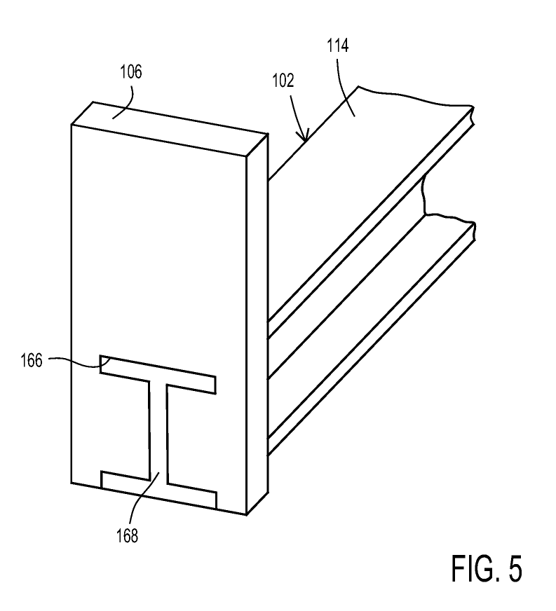

Referring now to FIG. 5, in the illustrative embodiment, the backstop 106 is coupled to an end 168 of the beam 102. The backstop 106 includes an aperture 166 for receiving the end of the beam 168. In the illustrative embodiment, the shape of the cross-section of the aperture 166 is substantially similar to the shape of the cross-section of the beam 102. While the beam 102 is shown as an I-beam and the aperture 166 is shown as having an I-shaped cross-section, it will be appreciated that any suitable cross-section for either beam 102 and/or aperture 166 may be employed and remain within the scope of the present disclosure. The backstop 106 may be coupled to the beam 102 via any suitable means, including, but not limited to, welding, bonding, adhesive, mechanical fastener(s), etc. In the illustrative embodiment, the interface of the aperture 166 and beam end 168 may be welded to couple the backstop 106 to the beam 102.

Referring now to FIGS. 1, 2 and 6, the actuating mechanism 108 is operable to move the wedge assembly 104 between a log-receiving position, wherein the wedge assembly 104 is spaced apart from the backstop 106, and a log-splitting position, wherein the wedge assembly 104 is driven towards the backstop 106 such that the wedge assembly 106 may penetrate and split a log. In the illustrative embodiment, the actuating mechanism 108 includes a hydraulic power pack 172 operatively coupled to a first hydraulic cylinder 116. The first hydraulic cylinder 116 may be ridgedly coupled to the beam 102 and wedge assembly 104 and operable to move the wedge assembly 104 (and mounting plate assembly 148) between a log-receiving position and a log-splitting position when powered by the hydraulic power pack 172.

In one embodiment, the apparatus 100 also includes a second hydraulic cylinder 120 coupled to the underside 122 of the beam 102 and frame 110. In one embodiment, the second hydraulic cylinder 120 is operatively coupled to the hydraulic power pack 172 and operable to move the beam 102 between a first, or horizontal position, and a second, or vertical, position. Thus, the apparatus 100 may be loaded with a log when the beam 102 is in the vertical position; whereafter, the beam 102 may be moved to the horizontal position for a log-splitting operation. While the illustrative first position is horizontal and the second position is vertical, it will be appreciated that the first and/or second position may be any suitable orientation and remain within the scope of the present disclosure.

The actuating mechanism 108 may be operated in a first mode, wherein the first cylinder 116 is active and operable to move the wedge assembly 104 (and mounting plate assembly 148) as previously discussed. The actuating mechanism 108 may also be operated in a second mode, wherein the second cylinder 120 is active and operable to move the beam 102 between the first position and second position. The actuating mechanism 108 may include a mode selecting switch for selectively switching the actuating mechanism 108 between the first and second modes. In the illustrative embodiment, the switch may be a valve 174; however, it will be appreciated that any device capable of permitting the actuating mechanism 108 to be switched between the first and second modes may be employed and remain within the scope of the present disclosure. A user may employ a single “joystick” 176 to activate the power pack 172 in either mode.

The apparatus 100 may also include one or more side trays 178 coupled to the beam. The side trays 178 may be angled toward the beam 102 so that logs may be urged to a position between the wedge assembly 104 and backstop 106. Each tray 178 may include a protective wall 180 for shielding a user, a vehicle coupled to the apparatus 100 and/or other components of the apparatus 100 during a log-splitting operation.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A log-splitting apparatus comprising:
a beam;
a mounting plate assembly coupled to the beam;
a wedge assembly for splitting logs, the wedge assembly coupled to the mounting plate assembly and comprising:
a rear wall;
a first sidewall having a first end and a second end, wherein the first end is coupled to the rear wall;
a second sidewall having a first end and a second end, wherein the first end is coupled to the rear wall in spaced relationship relative to the first sidewall first end, and wherein the first side wall and second sidewall are arranged at an acute angle relative to one another such that the first sidewall second end and second sidewall second end are adjacent to one another and such that the rear wall, first sidewall and second sidewall define an interior cavity;
one or more inserts disposed within the interior cavity, wherein each of the inserts is coupled to at least one of the rear wall, first wall and second wall; and
a wedge tip operable to penetrate a log, the wedge tip coupled to the first sidewall second end and the second sidewall second end;
a backstop coupled to the beam; and
an actuating mechanism coupled to at least one of the wedge assembly and backstop, the actuating mechanism operable to move at least one of the wedge assembly and backstop from a log-receiving position to a log-splitting position.

2. The log-splitting apparatus of claim 1 wherein the mounting plate assembly is slidingly coupled to the beam and wherein the actuating mechanism is coupled to the wedge assembly.

3. The log-splitting apparatus of claim 1 wherein the beam is an I-beam comprising a substantially horizontal upper portion.

4. The log-splitting apparatus of claim 3 wherein the mounting plate assembly includes a channel for slidingly receiving at least a portion of the upper portion of the I-beam.

5. The log-splitting apparatus of claim 3 wherein the mounting plate assembly comprises: an upper plate; a side plate coupled to the upper plate, wherein the side plate is substantially perpendicular to the upper plate; and a lower plate coupled to the side plate, wherein the lower plate is substantially parallel with the upper plate, and wherein the lower plate is substantially perpendicular with the side plate, and wherein the upper plate, side plate and lower plate define a channel operable to slidingly receive at least a portion of the upper portion of the I-beam.

6. The log-splitting apparatus of claim 1 wherein the cavity has a triangular cross-section.

7. The log-splitting apparatus of claim 6 wherein at least one insert has a generally triangular cross-section.

8. The log-splitting apparatus of claim 1 wherein the actuating mechanism includes a hydraulic power pack.

9. A log-splitting apparatus comprising:
a beam having a cross-section;
a backstop having an aperture for receiving the beam therein, wherein the aperture has a cross-section, and wherein the aperture cross-section and beam cross-section are substantially similar in shape, and wherein the backstop is ridgedly coupled to the beam;
a wedge assembly for splitting logs, the wedge assembly coupled to the beam; and
an actuating mechanism coupled to the wedge assembly, the actuating mechanism operable to move the wedge assembly from a log-receiving position to a log-splitting position.

10. The log-splitting apparatus of claim 9 wherein the beam is an I-beam.

11. The log-splitting apparatus of claim 9 wherein the backstop and the beam are coupled adjacent to the backstop aperture.

12. The log-splitting apparatus of claim 11 wherein the backstop and beam are coupled via welding.

13. The log-splitting apparatus of claim 9 wherein the actuating mechanism includes a hydraulic power pack.

14. A log-splitting apparatus comprising:
a beam;
a backstop coupled to the beam;
a wedge assembly for splitting logs, the wedge assembly coupled to the beam; and
an actuating mechanism coupled to the beam and at least one of the wedge assembly and backstop, wherein the actuating mechanism is capable of being operated in a first mode, wherein the actuating mechanism is operable to move the beam between a first position and a second position, and wherein the actuating mechanism is capable of being operated in a second mode, wherein the actuating mechanism is operable to move at least one of the wedge assembly and backstop from a log-receiving position to a log-splitting position.

15. The log-splitting apparatus of claim 14 further comprising a mode selecting switch for selectively switching the actuating mechanism between the first mode and second mode.

16. The log-splitting apparatus of claim 15 wherein the switch is a valve.

17. The log-splitting apparatus of claim 14 wherein the first mode beam first position is substantially horizontal.

18. The log-splitting apparatus of claim 17 wherein the first mode beam second position is substantially vertical.

19. The log-splitting apparatus of claim 14 wherein the wedge assembly is slidingly coupled to the beam and wherein the actuating mechanism is coupled to the wedge assembly.

20. The log-splitting apparatus of claim 14 wherein the actuating mechanism includes a hydraulic power pack.
